(19) United States
(12) Patent Application Publication
(10) Pub. No.: US 2026/0106316 A1
(43) Pub. Date: Apr. 16, 2026

(54) Film for Gas Venting, Manufacturing Method Thereof, and Secondary Battery Including the Film

(71) Applicant: LG Energy Solution, Ltd., Seoul (KR)

(72) Inventors: Yeji Lim, Deajeon (KR); Byoungsoo Lee, Deajeon (KR); Nak Hee Choi, Deajeon (KR)

(73) Assignee: LG Energy Solution, Ltd., Seoul (KR)

(21) Appl. No.: 19/357,392

(22) Filed: Oct. 14, 2025

(30) Foreign Application Priority Data
Oct. 16, 2024 (KR) 10-2024-0141185
Sep. 26, 2025 (KR) 10-2025-0140182

(51) Int. Cl. H01M 50/30; B05D 1/00; H01M 50/392

(52) U.S. Cl. CPC H01M 50/394; B05D 1/005; H01M 50/392; B05D 2201/02; B05D 2518/10

(57) ABSTRACT

A gas venting film includes an active layer and a support layer from a side facing the inside of the secondary battery. The active layer includes polydimethylsiloxane, and a ratio of forward permeability of gas generated from the inside of the secondary battery to reverse permeability of air is about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

### CROSS-REFERENCE TO RELATED APPLICATIONS

This application claims priority from Korean Patent Application No. 10-2024-0141185 filed on Oct. 16, 2024 and Korean Application No. 10-2025-0140182 filed on Sep. 26, 2025, with the Korean Intellectual Property Office, the disclosures of which are incorporated herein by reference.

### TECHNICAL FIELD

The present disclosure relates to a film for gas venting, a manufacturing method thereof, and a secondary battery including the same.

### BACKGROUND

Due to the abnormal operating conditions in a secondary battery, such as decomposition of an electrolyte, an internal short circuit, an overcharged state exceeding allowable current and voltage, exposure to high temperature, or deformation caused by drop or external impact, a swelling phenomenon in which the battery swells occurs, and when the amount of generated gas continuously increases (sustained swelling phenomenon occurs), ignition or explosion of the battery may result. Recently, as the usage environment of secondary batteries has become harsher and the capacity has increased in size, the necessity to more effectively control the problem of decreased safety due to gas generation inside the battery has grown.

For example, Korean Patent Laid-Open Publication No. 2015-0034498 proposes a battery in which a venting hole for discharging gas inside a pouch is formed in a pouch case, and a venting cover that opens when the internal gas pressure of the case reaches a reference value covers the venting hole, so that the sealing property of the pouch-type battery is maintained under normal circumstances while rapid venting is possible in an accident situation, thereby ensuring quality and safety.

### SUMMARY

The present disclosure provides a gas venting film that is capable of continuously and non-destructively discharging gas generated inside a secondary battery not only under high-pressure conditions but also under low-pressure conditions, effectively blocking external moisture and atmosphere (air) from flowing into the secondary battery, and exhibiting excellent resistance to an electrolyte.

The present disclosure implements the film with a simple structure and/or material, thereby simplifying a process and improving price competitiveness.

The present disclosure provides a secondary battery that further improves stability and lifespan by including the film in at least a portion of the secondary battery.

One aspect of the present disclosure relates to a gas venting film having different gas permeability characteristics between both surfaces, configured to discharge gas generated from an inside of a secondary battery to an outside while preventing air and water vapor from the outside from permeating into the secondary battery, the gas venting film including an active layer and a support layer from a side facing the inside of the secondary battery, in which the active layer includes polydimethylsiloxane, and a ratio of forward permeability of gas generated from the inside of the secondary battery to reverse permeability of air is about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

In one embodiment, the active layer may be derived from a polydimethylsiloxane precursor and a curing agent.

In one embodiment, a weight ratio of the polydimethylsiloxane precursor to the curing agent in the active layer may be about 1 to 10.

In one embodiment, the active layer may include at least one selected from polyimide, polytetrafluoroethylene, polypropylene, fluorine-based polymers, and combinations thereof.

In one embodiment, a thickness ratio of the support layer to the active layer may be about 0.85 or less.

In one embodiment, the active layer may have a thickness of about 120 μm to 1,000 μm.

In one embodiment, the support layer includes a porous support and a polymer coating layer on at least one surface of the porous support.

In one embodiment, the porous support may be in a nonwoven form, a woven form, or a mesh form in which polymer fibers are irregularly entangled.

In one embodiment, the polymer coating layer may include at least one selected from polysulfone, polyethersulfone, polycarbonate, polyethylene oxide, polyimide, polyetherimide, polyetheretherketone, polypropylene, polymethylpentene, polymethylchloride, polyvinylidene fluoride, and combinations thereof.

In one embodiment, the support layer may have a tensile strength of about 0.1 kgf/mm² to 10 kgf/mm².

In one embodiment, the support layer may have a thickness of less than about 140 μm.

In one embodiment, the film may have a thickness of about 200 μm to 1,000 μm.

In one embodiment, the active layer and the support layer may be adjacent to each other.

Another aspect of the present disclosure relates to a secondary battery including, at least in part, the gas venting film of claim 1, in which a gas generated from the inside of the secondary battery is non-destructively discharged to the outside through the gas venting film.

Still another aspect of the present disclosure relates to a gas venting film having different gas permeability characteristics between both surfaces, configured to discharge gas generated from an inside of a secondary battery to an outside while preventing air and water vapor from the outside from permeating into the secondary battery, the method including applying a composition for forming an active layer on a support layer, in which the gas venting film has a ratio of forward permeability of gas generated from the inside of the secondary battery to reverse permeability of air of about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

In one embodiment, the applying may be performed at a speed of about 100 rpm to 900 rpm.

In one embodiment, the applying may be performed for about 1 second to 100 seconds.

In one embodiment, the composition for forming the active layer may include a polydimethylsiloxane precursor and a curing agent.

In one embodiment, a weight ratio of the polydimethylsiloxane precursor to the curing agent may be about 1 to 10.

In one embodiment, the composition for forming the active layer may include at least one selected from polyimide, polytetrafluoroethylene, polypropylene, fluorine-based polymers, and combinations thereof.

The present disclosure provides a gas venting film that is capable of continuously and non-destructively discharging gas generated inside a secondary battery not only under high-pressure conditions but also under low-pressure conditions, effectively blocking external moisture and atmosphere (air) from flowing into the secondary battery, and exhibiting excellent resistance to an electrolyte.

The present disclosure may implement the film for gas venting with a relatively simple structure and/or material, thereby simplifying a process and improving price competitiveness.

The present disclosure provides a secondary battery that further improves stability and lifespan by including the film for gas venting in at least a portion of the secondary battery.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIGS. 1 and 2 illustrate a film structure according to one example of the present disclosure.

FIG. 3 and FIGS. 4A and 4B are schematic diagrams of a cylindrical secondary battery according to one example of the present disclosure.

FIGS. 5A to 5C are schematic diagrams of a prismatic secondary battery according to one example of the present disclosure.

FIGS. 6A and 6B is a schematic diagram of a pouch-type case according to one example of the present disclosure.

FIG. 7 illustrates a flowchart of a method for manufacturing a film according to one example of the present disclosure.

FIG. 8 is a digital microscope (DM) image observing results of an electrolyte resistance evaluation of a film according to Examples 4 to 8 of the present disclosure.

FIG. 9 is a digital microscope (DM) image observing results of an electrolyte resistance evaluation of a film according to Examples 1 to 3 of the present disclosure.

Corresponding reference characters indicate corresponding components throughout the several views of the drawings. The drawing figures presented are illustrated for simplicity and clarity and have not necessarily been drawn to scale.

For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Words and terms used in the detailed description and the claims herein should not be interpreted to be limited to their usual or dictionary meanings, but should be interpreted to have meanings and concepts that correspond to the technical idea of the present disclosure in compliance with the principle that inventors may appropriately define terms and concepts for the purpose of best describing the present disclosure.

Accordingly, it can be appreciated that the configurations of embodiments described herein are merely examples of the present disclosure, which do not exhaustively represent the technical idea of the present disclosure, and various equivalents and modifications may be made to substitute the present disclosure at the time of filing the present disclosure.

Through the specification, singular expressions include plural expressions unless the context clearly indicates otherwise.

Through the specification, when a part is said to “include” a component, this does not exclude other components, but rather includes other components, unless otherwise specifically stated. Therefore, for example, a composition including compound A may further include another compound in addition to compound A.

However, the term “including” also encompasses, as specific embodiments thereof, more restrictive meanings of “consisting essentially of” and “consisting of.” For example, a composition including compound A may also consist essentially of compound A or consist of compound A.

In connection therewith, it should be understood that the terms such as “comprise,” “include,” or “have,” are intended to specify the presence of a feature, number, step, component, or combination thereof, but do not exclude in advance the possibility of the presence or addition of one or more other features, numbers, steps, components, or combinations thereof.

In the present specification, when any member is described as being “on” another member, this includes not only a case where the member is in contact with the other member but also a case where another member or material is interposed between the two members.

In the present specification, when an amount, concentration, or other value or parameter is given as a range, a preferred range, or a list of upper or lower preferable limits, all ranges formed by any pair of upper range limits or preferable values and lower range limits or preferable values shall be specifically disclosed regardless of whether ranges are separately described. When a numerical range is mentioned in the present specification, unless otherwise stated, for example, by limiting terms such as exceeding or less than, the range is intended to include its end values as well as all integers and fractions within the range. The scope of the present disclosure is intended not to be limited by specific values mentioned in defining the ranges.

Among the physical properties referred to in the present specification, in cases where a measurement temperature affects the physical property, the physical property is measured at room temperature unless otherwise specifically defined. The term “room temperature” means a natural temperature that is not heated or cooled, and for example, refers to any one temperature within a range of about 10° C. to 30° C., about 23° C., or about 25° C. In addition, unless otherwise specifically defined, a unit of temperature in the present specification is ° C.

As used herein, the terms “about”, “approximately”, “substantially” refer to a range of, or approximation to a numerical value or degree, taking into account inherent manufacturing and material tolerances (e.g., ±5%).

Among the physical properties referred to in the present specification, in cases where a measurement pressure affects the physical property, unless otherwise specifically defined, the physical property is measured at normal pressure, that is, atmospheric pressure of about 1 atmosphere.

In conventional secondary batteries, there are problems in that, in order to vent gas generated inside the battery, a venting portion is installed, and after a venting cover of the venting portion is opened, the battery may not be reused, and in accident situations where the venting cover is not properly opened due to an unexpected reason, the battery does not include another alternative element capable of preventing the accident, and inflow of external moisture or atmosphere through the venting cover is not considered.

The first aspect of the present disclosure relates to a gas venting film having different gas permeability characteristics between both surfaces, configured to discharge gas generated from an inside of a secondary battery to an outside and to prevent air and water vapor from the outside from permeating into the secondary battery.

In the present specification, the term “inside of the secondary battery” may refer to a space in which an electrode assembly and an electrolyte are located with a case as a boundary, and the term “outside of the secondary battery” may refer to a space other than the inside with the case as a boundary. The case may be, for example, a cylindrical can/cap assembly constituting a cylindrical secondary battery, a prismatic can/base plate constituting a prismatic secondary battery, or a pouch constituting a pouch-type secondary battery.

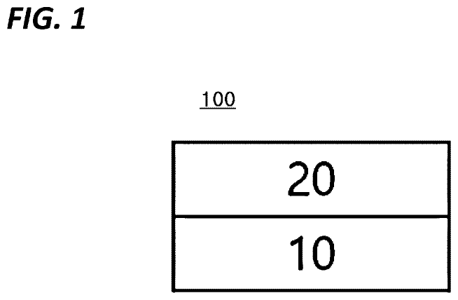

Referring to FIG. 1, a gas venting film 100 (hereinafter, referred to as a “film”) according to one embodiment of the present disclosure may include a support layer 10 that is a surface facing the outside of the secondary battery and an active layer 20 that is a surface facing the inside of the secondary battery when the gas venting film is installed in the secondary battery. Accordingly, the active layer 20 may be directly exposed to the electrolyte inside the secondary battery and/or vapor derived therefrom, and the support layer 10 may be directly exposed to moisture and/or air (atmosphere) outside the secondary battery.

In one example, the active layer 20 may include polydimethylsiloxane. For example, the active layer may include polydimethylsiloxane in an amount of about 80 wt % or more. In another example, the active layer 20 may include polydimethylsiloxane in an amount of about 85 wt % or more, about 90 wt % or more, about 95 wt % or more, about 99 wt % or more, about 99.9 wt % or more, or about 99.99 wt % or more, or includes polydimethylsiloxane in an amount of about 100 wt % or less.

For example, the active layer 20 may be derived from a polydimethylsiloxane precursor and a curing agent. In the present disclosure, the polydimethylsiloxane precursor may refer, for example, to PDMAA material. In the present specification, the expression “the active layer is derived from a polydimethylsiloxane precursor and a curing agent” may mean that the active layer 20 is derived from a composition for forming an active layer including a polydimethylsiloxane precursor and a curing agent. The active layer 20 of the present disclosure is, for example, a layer in which the polydimethylsiloxane precursor and the curing agent are cured by other factors (e.g., light or heat), and may include PDMS kit B having a structure in which PDMS strands are aggregated by curing. The curing agent may be, for example, dimethyl methylhydrogen siloxane.

The active layer 20 may have a weight ratio of the polydimethylsiloxane precursor to the curing agent of, for example, about 1 to 10. The active layer 20 may be, for example, a layer derived from a composition for forming an active layer having a weight ratio of the polydimethylsiloxane precursor to the curing agent of about 1 to 10. In another example, the active layer 20 may have a weight ratio of the polydimethylsiloxane precursor to the curing agent of about 1.5 or more, 2 or more, 2.5 or more, 3 or more, 3.5 or more, 4 or more, or 4.5 or more, or about 9.5 or less, 9 or less, 8.5 or less, 8 or less, 7.5 or less, 7 or less, 6.5 or less, 6 or less, or 5.5 or less.

In still another example, the active layer 20 may include at least one selected from polyimide, polytetrafluoroethylene, polypropylene, fluorine-based polymers, and combinations thereof. The active layer 20 may include, for example, at least one selected from polyimide, polytetrafluoroethylene, polypropylene, fluorine-based polymers, and combinations thereof in an amount of about 80 wt % or more. In still another example, the active layer may include at least one selected from polyimide, polytetrafluoroethylene, polypropylene, fluorine-based polymers, and combinations thereof in an amount of about 85 wt % or more, about 90 wt % or more, about 95 wt % or more, about 99 wt % or more, about 99.9 wt % or more, or about 99.99 wt % or more, or includes such component in an amount of about 100 wt % or less.

By allowing the active layer 20 to be formed with the above materials and weight ratios through a simple structure and/or material, the film of the present disclosure may continuously and non-destructively discharge a gas generated from the inside of the secondary battery under not only high-pressure conditions but also low-pressure conditions, may effectively block inflow of external moisture and atmosphere (air) into the secondary battery, and may exhibit excellent resistance to an electrolyte.

In addition, such effects may be further enhanced by controlling a thickness of the active layer 20 as described below.

In the present specification, the term “high-pressure condition” refers to a pressure condition in which at least a portion of a case of a secondary battery is damaged and there is a considerable risk of ignition or explosion, and may refer, for example, to a pressure exceeding about 20 psi, exceeding about 50 psi, or exceeding about 100 psi. The term “low-pressure condition” refers to a range of about 20 psi or less, which is above atmospheric pressure at which a gas generated inside the secondary battery may be discharged to an outside while a risk of damage to the case is relatively low.

According to one embodiment of the present disclosure, a film 100 may have a ratio of forward permeability of gas generated from the inside of the secondary battery to reverse permeability of air of about 2 or more under a relative pressure of about 15 psi or about 50 psi. In another example, the film 100 may have, under a relative pressure of about 15 psi or about 50 psi, a ratio of forward permeability of gas generated from the inside of the secondary battery to reverse permeability of air of about 2.5 or more, 3 or more, 3.5 or more, 4 or more, 4.5 or more, 5 or more, 5.5 or more, 6 or more, 6.5 or more, 7 or more, 7.5 or more, 8 or more, 8.5 or more, 9 or more, or 9.5 or more, or about 20 or less, 18 or less, 16 or less, or 14 or less. In the present specification, the term “forward direction” is a direction from the inside of the secondary battery toward the outside of the secondary battery, and the term “reverse direction” is a direction from the outside of the secondary battery toward the inside of the secondary battery.

According to one embodiment of the present disclosure, the film 100 may have a thickness ratio of the support layer 10 to the active layer 20 of about 0.85 or less. In another example, the thickness ratio of the support layer to the active layer 20 may be about 0.8 or less, 0.75 or less, 0.7 or less, 0.65 or less, 0.6 or less, 0.55 or less, or 0.5 or less, or may be about 0.1 or more, 0.2 or more, 0.3 or more, 0.4 or more, 0.5 or more, 0.6 or more, or 0.7 or more. The present disclosure may provide a film in which the active layer 20 having the above characteristics and the support layer 10 described below are combined at a predetermined thickness ratio, thereby, through a simple structure and/or material, continuously and non-destructively discharging gas generated inside the secondary battery under not only high-pressure conditions but also low-pressure conditions, effectively blocking inflow of external moisture and atmosphere (air) into the secondary battery, and exhibiting excellent resistance to an electrolyte.

For example, the active layer 20 may have a thickness of about 120 μm to 1,000 μm. In the present specification, the term “thickness” may refer to an average thickness, a maximum thickness, and/or a minimum thickness among thicknesses measured at arbitrary positions. In another example, the active layer 20 may have a thickness of about 125 μm or more, 130 μm or more, 135 μm or more, 140 μm or more, 145 μm or more, 150 μm or more, 155 μm or more, 160 μm or more, 165 m or more, 170 μm or more, 175 μm or more, 180 μm or more, 185 μm or more, 190 m or more, 195 μm or more, 200 μm or more, 205 μm or more, or 210 μm or more, or about 950 μm or less, 900 μm or less, 850 μm or less, 800 μm or less, 750 μm or less, 700 μm or less, 650 μm or less, 600 μm or less, 550 μm or less, 500 μm or less, 450 μm or less, 400 μm or less, 350 μm or less, 300 μm or less, 250 μm or less, 200 μm or less, or 150 μm or less. In the present disclosure, the thickness of the active layer 20 may be controlled by a coating and/or curing method of a composition for forming the active layer, which will be described below.

The film 100 of the present disclosure may further improve resistance to an electrolyte by controlling the thickness ratio between the active layer 20 and the support layer 10 and/or the thickness of the active layer 20 as described above. In the present specification, the expression “the film has resistance to a secondary battery electrolyte” may mean that even when a surface of the film 100 facing the inside of the secondary battery is initially exposed or exposed for a considerable time to the electrolyte and/or vapor derived therefrom, the film is not dissolved and does not absorb or permeate the electrolyte.

In addition, for example, the active layer 20 may absorb gas generated from the inside of the secondary battery and transfer the gas toward the outside. The gas may include, for example, gas generated when a solid electrolyte interphase (SEI) film is formed during a process of manufacturing the secondary battery and/or abnormal gas generated due to decomposition of an electrolyte, excessive moisture content of the secondary battery, a short circuit, or over-charge and/or over-discharge. The gas may have a composition partially different depending on a combination of an electrolyte used in the secondary battery, a solvent of the electrolyte, a positive electrode active material, a negative electrode active material, and a binder, but in general, the gas may exhibit similar properties in that CO₂ is a main component. The gas may include, for example, H₂, O₂, CO, CO₂, and/or hydrocarbon gases such as CH₄, C₂H₂, C₂H₄, C₂H₆, C₃H₆, and C₃H₈, and combinations thereof, and a ratio of CO₂ gas to a total generated gas amount may be about 50% or more. By including the active layer 20 having the above characteristics, the film 100 of the present disclosure may allow gas generated from the inside of the secondary battery to permeate in a forward direction (from an inside of the film toward an outside of the film) through a solution-diffusion mechanism.

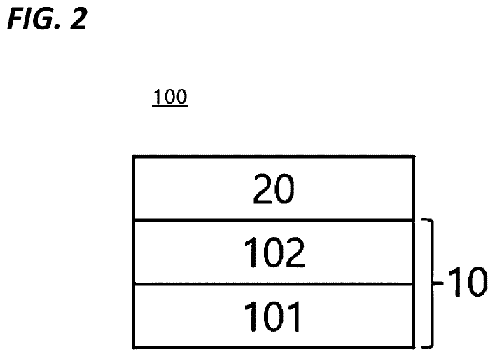

Referring to FIG. 2, the support layer 10 of the gas venting film 100 according to another embodiment of the present disclosure may include, for example, a porous support 101 and a polymer coating layer 102 on at least one surface of the porous support.

The porous support 101 may be, for example, in a nonwoven form, a woven form, or a mesh form in which polymer fibers are irregularly entangled. The polymer may be, for example, polypropylene (PP), poly(methyl methacrylate) (PMMA), polyethylene (PE), polyethylene terephthalate (PET), or polyethersulfone (PES), but is not limited thereto.

The porosity of the porous support 101 may be about 10% to 90%, but is not limited thereto. The porosity may be measured by Archimedes' principle. In another example, the porosity of the porous support may be about 20% or more, 30% or more, 40% or more, 50% or more, 60% or more, 70% or more, or 80% or more, or may be about 80% or less, 70% or less, 60% or less, 50% or less, 40% or less, 30% or less, or 20% or less.

For example, the polymer coating layer 102 may include at least one selected from polysulfone, polyethersulfone, polycarbonate, polyethylene oxide, polyimide, polyetherimide, polyetheretherketone, polypropylene, polymethylpentene, polymethyl chloride, polyvinylidene fluoride, and combinations thereof. According to one embodiment, the polymer coating layer 102 may be polysulfone from the viewpoint of reinforcing a supporting role or gas permeability and selectivity.

For example, the support layer 10 may have a thickness of less than about 140 μm. In another example, the thickness of the support layer may be about 60 μm or more, 70 μm or more, 80 μm or more, or 90 μm or more, or may be less than about 130 μm, less than about 120 μm, or less than about 110 μm.

For example, the support layer 10 may have a tensile strength of about 0.1 kgf/mm² to 10 kgf/mm². The tensile strength may be measured according to an evaluation method described below.

The support layer 10 may have a water contact angle of, for example, about 80° to 120°. In the present specification, the term “water contact angle of the support layer” may refer to a water contact angle of a surface of the support layer 10 that faces external air. In another example, the water contact angle of the support layer 10 may be, for example, about 85° or more, 90° or more, or 95° or more, or may be about 115° or less, 110° or less, or 105° or less.

By including the support layer 10 having the above characteristics, the film of the present disclosure may maintain its shape and may have a desired mechanical strength. In addition, when the support layer 10 is combined with the active layer 20 described above, the film may exhibit asymmetric gas permeability and electrolyte resistance that are unique to the film of the present disclosure. Such characteristics may be more effectively expressed by control of configurations described below.

According to one embodiment of the present disclosure, the film 100 may have a thickness of about 200 μm to 1,000 μm. In another example, the film 100 may have a thickness of about 220 μm or more, 240 μm or more, 260 μm or more, 280 μm or more, or 300 μm or more, or may be about 900 am or less, 800 am or less, 700 μm or less, 600 μm or less, 500 μm or less, 450 μm or less, 400 μm or less, 350 m or less, 300 μm or less, or 250 μm or less.

According to one embodiment of the present disclosure, the film 100 may be configured such that the active layer 20 and the support layer 10 are adjacent to each other. In the present specification, the expression “the active layer 20 and the support layer 10 are adjacent” may mean that the active layer 20 and the support layer 10 are directly stacked without an intermediate layer interposed therebetween. From the viewpoint of improving processability and productivity through structural simplification, the film 100 according to one embodiment of the present disclosure may include only the support layer 10 and the active layer 20. By such a simple structure, the present disclosure may provide a film 100 that continuously and non-destructively discharges gas generated from the inside of the secondary battery under not only high-pressure conditions but also low-pressure conditions, effectively blocks inflow of external moisture and atmosphere (air) into the secondary battery, and exhibits excellent resistance to an electrolyte.

The second aspect of the present disclosure relates to a secondary battery that includes, at least in part, the gas venting film 100 according to one embodiment of the present disclosure, and in which gas generated from an inside of the secondary battery is discharged to an outside in a non-destructive manner through the film 100.

Matters relating to the first aspect of the present disclosure may also be equally applied to the second aspect unless otherwise specifically described.

Conventionally, in order to solve a problem that gas generation increases due to abnormal operation of the battery and causes ignition or explosion, a venting system has been introduced. The venting system is, for example, a device that allows internal gas to be discharged to an outside when an internal pressure of a secondary battery reaches a certain level, and after venting, the secondary battery is difficult to reuse, and in cases where the venting system does not properly operate due to an unexpected reason, a system for enhancing safety as an alternative is insufficient. However, according to the present disclosure, by including or installing the gas venting film 100 as described above in at least a part of the secondary battery, gas generated from the inside of the battery may be continuously and non-destructively discharged not only under high-pressure conditions but also under low-pressure conditions, thereby further improving lifetime, resistance, and safety of the battery. In addition, when the film 100 is applied to the battery in combination with a conventional venting system, the above effects may be further enhanced.

The secondary battery may include, for example, an electrode assembly, an electrolyte, and/or a case accommodating the same, and may further include, without particular limitation, other known configurations introduced into a secondary battery as long as the purpose of the present disclosure is not impaired.

The secondary battery may be, for example, a cylindrical secondary battery, a prismatic secondary battery, and/or a pouch-type secondary battery.

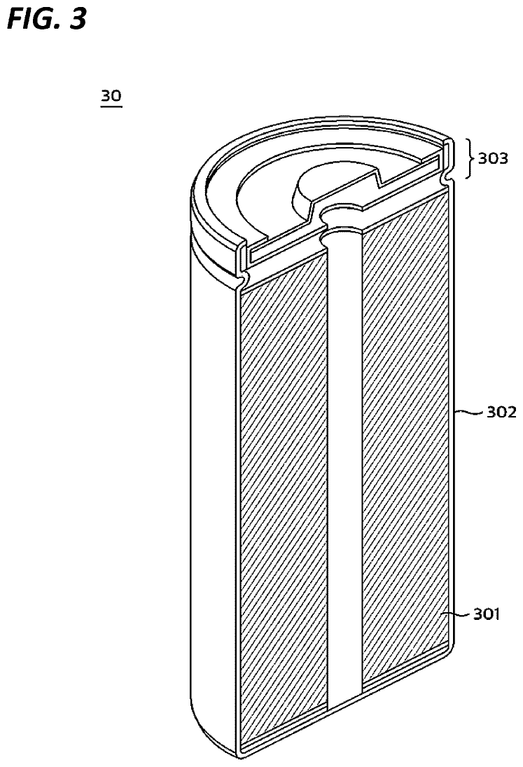

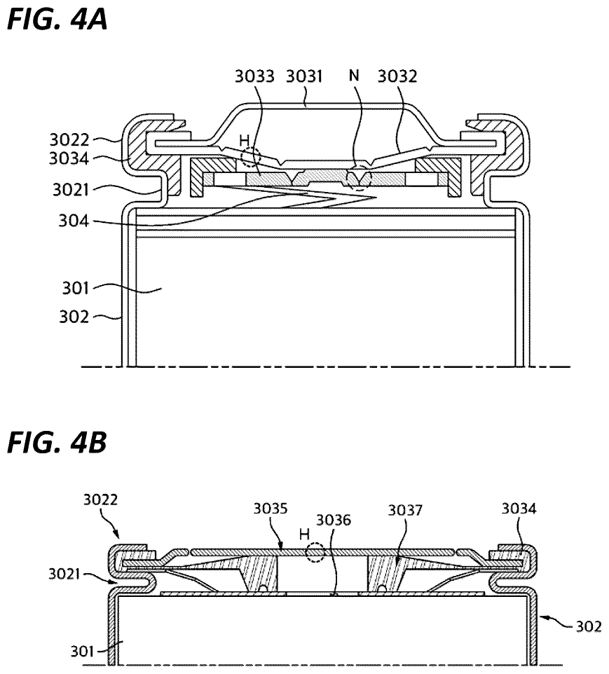

Hereinafter, examples in which the gas venting film is applied to a cylindrical secondary battery will be described with reference to FIGS. 3 and 4A and 4B.

The cylindrical secondary battery 30 of the present disclosure may include, for example, an electrode assembly 301, a cylindrical can 302 that accommodates the electrode assembly, and/or a cap assembly 303 that seals an open end of the cylindrical can. The cylindrical can 302 may include, for example, a bottom portion of the can and/or a side portion of the can. The bottom portion of the can 302 may refer, for example, to a surface opposite to the open end of the can where the cap assembly 303 is mounted. The cylindrical secondary battery 30 according to one embodiment of the present disclosure may be manufactured by accommodating the electrode assembly 301 in the cylindrical can 302, injecting an electrolyte into the cylindrical can 302, and sealing an open upper surface of the cylindrical can 302 by mounting the cap assembly 303. At this time, the cap assembly 303 may be electrically connected to the electrode assembly through an electrode tab (e.g., a positive electrode tab) extending from the electrode assembly 301, or may be implemented as a tab-less structure of the cap assembly. The tab-less structure may be, for example, a structure in which each of a positive electrode and a negative electrode included in the electrode assembly 301 includes a non-coated portion, and each non-coated portion is electrically connected to an electrode terminal.

The cylindrical secondary battery 30 may include, for example, one or more holes H in the bottom portion of the can, the side portion of the can, and/or the cap assembly 303. In one example, the cylindrical secondary battery 30 may include a cylindrical can 302 that accommodates the electrode assembly and a cap assembly 303 mounted on an upper end of the cylindrical can 302, and may include a hole H in a portion of the cap assembly 303, and the hole H may be covered with the gas venting film 100 described above. The hole H may, for example, also serve as an electrolyte injection hole, or may not serve as an electrolyte injection hole. When the hole is used as an electrolyte injection hole, a process of forming a hole is not required, thereby improving processability.

According to one embodiment, the structure of the cap assembly 303 and the position of the hole H will be described with reference to FIGS. 4A and 4B, but this is merely one example and the present disclosure is not limited thereto.

A cylindrical secondary battery 30 equipped with the cap assembly 303 may have, for example, a structure as illustrated in FIG. 4A. The cap assembly 303 may include, for example, a top cap 3031, a safety vent 3032, and/or a current interrupt device (CID) filter 3033. The top cap 3031 may, for example, form a positive electrode terminal in a protruded shape and have one or more exhaust holes (not illustrated) perforated therein. A safety vent 3032 may be located, for example, at a lower portion of the top cap. The CID filter 3033 may be, for example, coupled at a portion of an upper surface to the safety vent 3032 and connected at a portion of a lower surface to an electrode of the electrode assembly 301. When gas is generated from the electrode assembly 301 due to causes such as overcharge or high temperature and internal pressure increases, the shape of the safety vent 3032 may be reversed, protruding upward to discharge gas. At this time, the CID filter 3033 may also move upward, and a notch region N may be broken to block the flow of current. This may prevent or suppress additional overcharge and explosion of the battery.

The cap assembly 303 may further include, for example, a gasket 3034 that provides airtightness and insulation between the top cap 3031 and the cylindrical can 302. The top cap 3031 may be pressed onto a beading portion 3021 formed in the cylindrical can 302 and may be fixed by a crimping portion 3022. The top cap 3031 is a component made of a conductive metal material and may cover an upper opening of the cylindrical can 302. The top cap 3031 may be electrically connected to a positive electrode (e.g., a positive electrode tab 304) of the electrode assembly 301 and may be electrically insulated from the cylindrical can 302 through the gasket. Therefore, the top cap 3031 may function as a positive electrode terminal of the cylindrical secondary battery 30. The top cap 3031 may include a protrusion formed protruding upward at a center portion thereof, and the protrusion may contact an external power source so that current is applied from the external power source. In such a cap assembly 303, the hole H may be formed, for example, in a portion of the safety vent 3032. In one example, the hole H may be formed in a portion indicated as H in FIG. 4A, but is not limited thereto and may be formed in a region other than a notch.

The cylindrical secondary battery 30 equipped with the cap assembly 303 may have, for example, a structure as illustrated in FIG. 4B. The cap assembly 303 may include, for example, a top plate 3035. The top plate 3035 is a conductive member functioning as a positive electrode terminal for connection to an external power source and may allow electrical connection with the external power source. The top plate 3035 may be electrically connected, for example, to a current collector plate 3036 disposed at an end of the positive electrode to deliver current to an outside. In one example, without separately extracting a positive electrode tab from the electrode assembly 301, direct connection with the top plate 3035 may be implemented through a disc-shaped or annular current collector plate disposed at an end of the electrode assembly, thereby implementing a tab-less structure and simplifying a manufacturing process. The current collector plate 3036 may have a known structure. The current collector plate 3036 may be, for example, made of a conductive metal material and may be electrically connected to the top plate 3035 located above. Accordingly, the current collector plate 3036 may enable stable electrical connection with the top plate without a tab structure, and may secure structural simplicity and electrical reliability of the positive electrode terminal. The cap assembly 303 may further include, for example, a spacer 3037 disposed between the top plate 3035 and the electrode assembly 301. The height of the spacer may correspond to a distance between the top plate 3035 and the electrode assembly 301. For example, the spacer 3037 may prevent or suppress the electrode assembly 301 from moving or shaking inside the cylindrical can 302. The cap assembly 303 may further include, for example, a gasket 3034 that provides airtightness and insulation between the top plate 3035 and the cylindrical can 302, and structures such as the crimping portion 3022 or the beading portion 3021 for mounting the cap assembly to the battery can may be equally applied to the content relating to FIG. 4a, but may also be replaced with known structures as long as the purpose of the present disclosure is not impaired. In such a cap assembly 303, the hole H may be formed, for example, in a portion of the top plate 3035. In one example, the hole H may be formed in a portion indicated as H in FIG. 4B, but is not limited thereto and may be formed in a region other than a notch.

The cap assembly 303 may have various structures depending on types of the cylindrical secondary battery 30, and may include a positive electrode, a negative electrode, or a non-polar type. A position of the hole H may vary depending on the structure of the cap assembly 303, but the position of the hole H is not particularly limited as long as the function of the cap assembly 303 may be smoothly maintained and the hole penetrates to connect an inside and an outside of the cylindrical secondary battery.

In another example, the cylindrical secondary battery 30 may include a cylindrical can 302 that accommodates the electrode assembly and a cap assembly 303 mounted on an upper end of the cylindrical can 302, and may include a hole H in a portion of the cylindrical can 302, and the hole H may be covered with the gas venting film 100 described above. The hole H may be included, for example, in a part of a bottom portion or a side portion of the cylindrical can 302, and in consideration of workability, the hole H may be formed in the bottom portion of the can where no curvature is present.

A diameter of the hole H may be, for example, about 0.1 mm to 100 mm. In another example, the diameter of the hole H may be about 0.5 mm or more or 1 mm or more, or may be 50 mm or less, 40 mm or less, 30 mm or less, 20 mm or less, 10 mm or less, 5 mm or less, 2 mm or less, or 1 mm or less, but is not particularly limited as long as a secondary battery having excellent gas venting effects by application of the gas venting film and excellent stability without electrolyte leakage may be provided.

The hole H may be covered with, for example, the gas venting film 100. For example, the gas venting film 100 may be attached or installed in the cylindrical secondary battery such that the gas venting film 100 covers the hole H. The diameter of the gas venting film 100 may be, for example, larger than a diameter of the hole H. The gas venting film 100 may be attached or installed in the cylindrical secondary battery by, for example, laser welding or heat fusion.

The cylindrical secondary battery 30 of the present disclosure may further include, without limitation, the configurations included in a known cylindrical secondary battery, as long as the purpose of the present disclosure is not impaired.

Through the above-described structure, the cylindrical secondary battery of the present disclosure may continuously and non-destructively discharge gas generated inside the secondary battery not only under high-pressure conditions but also under low-pressure conditions, and may effectively block the inflow of external moisture and atmosphere (air) into the secondary battery, thereby improving stability and lifetime characteristics of the battery.

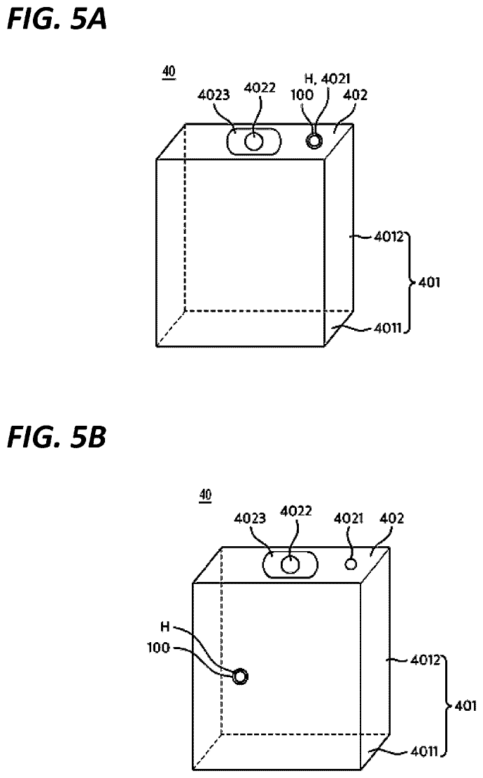

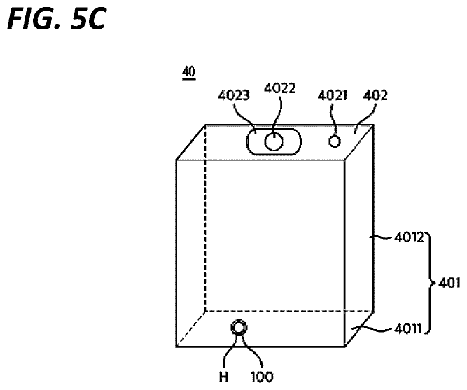

Hereinafter, examples in which the gas venting film is applied to a prismatic secondary battery will be described with reference to FIGS. 5A to 5C.

The prismatic secondary battery 40 of the present disclosure may include, for example, an electrode assembly, a prismatic can 401 that accommodates the electrode assembly, and/or a base plate 402 mounted on an upper end of the prismatic can.

The prismatic can 401 may include, for example, a can bottom portion 4011 and/or a can side portion 4012, and an upper end of the prismatic can may be open. A base plate 402 may be mounted, for example, on the upper end of the prismatic can 401. The base plate 402 may be mounted, for example, after or before electrolyte injection. The prismatic secondary battery 40 may be sealed by the base plate 402.

One or more of the can bottom portion 4011, the can side portion 4012, and/or the base plate 402 of the prismatic secondary battery 40 may include, for example, a hole H. In one example, as illustrated in FIG. 5A, the prismatic secondary battery 40 may include the prismatic can 401 that accommodates the electrode assembly and the base plate 402 mounted on the upper end of the prismatic can, and may include a hole H in a portion of the base plate, and the hole H may be covered with the gas venting film 100 described above. The hole H may be, for example, an electrolyte injection hole 4021, or may be a hole H other than the electrolyte injection hole. When the hole is used as an electrolyte injection hole, a process of separately forming a hole is not required, thereby improving processability. In another example, as illustrated in FIG. 5B or FIG. 5C, the prismatic secondary battery 40 may include the prismatic can 401 that accommodates the electrode assembly and the base plate 402 mounted on the upper end of the prismatic can, and may include a hole H in a part of the can bottom portion 4011 or the can side portion 4012 of the prismatic can, and the hole H may be covered with the gas venting film 100 described above.

The diameter of the hole H may be, for example, about 0.1 mm to 100 mm. In another example, the diameter of the hole H may be about 0.5 mm or more or 1 mm or more, or may be 50 mm or less, 40 mm or less, 30 mm or less, 20 mm or less, 10 mm or less, 5 mm or less, 2 mm or less, or 1 mm or less, but is not particularly limited as long as a secondary battery having excellent gas venting effects by application of the gas venting film and excellent stability without electrolyte leakage may be provided.

The hole H may be covered with, for example, the gas venting film 100. That is, the gas venting film 100 may be attached or installed in the prismatic secondary battery such that the gas venting film 100 covers the hole H. A diameter of the gas venting film 100 may be, for example, larger than a diameter of the hole H. The gas venting film 100 may be attached or installed in the prismatic secondary battery by, for example, laser welding or heat fusion.

The base plate 402 may further include, for example, an electrode terminal 4022 connected to an electrode tab (e.g., a negative electrode tab) of the electrode assembly. A position of the electrode terminal 4022 may be, for example, a central portion of the base plate, but is not limited thereto. The electrode terminal may be, for example, protruded. In addition, an insulating member 4023 may be interposed, for example, between the protruded electrode terminal 4022 and the base plate 402, and may provide electrical insulation from the base plate 402, which is connected to another electrode (e.g., a positive electrode) of the electrode assembly and serves as an electrode terminal itself.

The prismatic secondary battery 40 of the present disclosure may further include, without limitation, configurations included in a known prismatic secondary battery, as long as the purpose of the present disclosure is not impaired.

Through the above-described structure, the prismatic secondary battery of the present disclosure may continuously and non-destructively discharge gas generated inside the secondary battery not only under high-pressure conditions but also under low-pressure conditions, and may effectively block inflow of external moisture and atmosphere (air) into the secondary battery, thereby improving stability and lifetime characteristics of the battery.

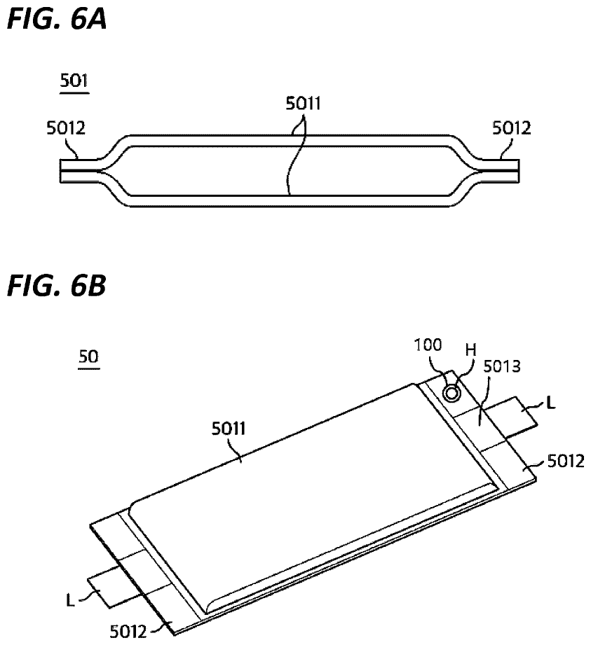

Hereinafter, examples in which the gas venting film is applied to a pouch-type secondary battery will be described with reference to FIGS. 6A and 6B.

The pouch-type secondary battery 50 of the present disclosure may include, for example, an electrode assembly and a pouch-type case 501. The pouch-type case 501 may include, for example, a body portion 5011 and/or a sealing portion 5012. The body portion 5011 may refer, for example, to a film region in which the electrode assembly is accommodated, and the sealing portion 5012 may refer, for example, to a film region that seals an edge of the body portion to block an inside of the battery from an outside. The sealing portion 5012 may be, for example, an edge portion of the pouch-type case, and may refer to a film region sealed by joining and/or fusing portions of the pouch-type case together. The sealing portion 5012 may extend, for example, along an edge from the body portion 5011.

One or more of the body portion 5011 and the sealing portion 5012 of the pouch-type case 501 may include, for example, a hole H. In one example, the pouch-type secondary battery 50 may include the pouch-type case 501 that accommodates the electrode assembly, the pouch-type case 501 may include the body portion 5011 and the sealing portion 5012, a part of the body portion 5011 may include the hole H, and the hole H may be covered with the gas venting film 100 described above. In another example, the pouch-type secondary battery 50 may include the pouch-type case 501 that accommodates the electrode assembly, the pouch-type case 501 may include the body portion 5011 and the sealing portion 5012, a part of the sealing portion 5012 may include the hole H, and the hole H may be covered with the gas venting film 100 described above. The sealing portion 5012 may include, for example, a region 5013 overlapping with a protrusion of an electrode lead, and from the viewpoint of improving film application effects, the hole H may be formed in a region of the sealing portion excluding the region 5013 overlapping with the protrusion of the electrode lead, but is not limited thereto.

A diameter of the hole H may be, for example, about 0.1 mm to 100 mm. In another example, the diameter of the hole H may be about 0.5 mm or more or 1 mm or more, or may be 50 mm or less, 40 mm or less, 30 mm or less, 20 mm or less, 10 mm or less, 5 mm or less, 2 mm or less, or 1 mm or less, but is not particularly limited as long as a secondary battery having excellent gas venting effects by application of the gas venting film and excellent stability without electrolyte leakage may be provided.

The hole H may be covered with, for example, the gas venting film 100. That is, the gas venting film 100 may be attached or installed in the pouch-type secondary battery such that the gas venting film 100 covers the hole H. The diameter of the gas venting film 100 may be, for example, larger than a diameter of the hole H. The gas venting film 100 may be attached or installed in the pouch-type secondary battery by, for example, laser welding or heat fusion.

The pouch-type case 501 may be, for example, manufactured by forming a pouch film laminate. The pouch film laminate may have, for example, a structure in which a substrate layer, a gas barrier layer, and/or a sealant layer are sequentially laminated, but is not limited thereto, and any known pouch film laminate may be used.

The substrate layer may be formed at an outermost layer of a pouch film laminate to protect the secondary battery from friction and impact with an outside, and may be formed of a polymer to electrically insulate the electrode assembly from the outside. The substrate layer may be made of, for example, one or more materials selected from polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber. In one embodiment, the substrate layer may be made of polyethylene terephthalate (PET), nylon, or a combination thereof having wear resistance and heat resistance. The substrate layer may have a single film structure made of one material or may have a composite film structure formed by two or more materials each forming a layer. The thickness of the substrate layer may be about 5 μm to 50 μm, but is not limited thereto.

The gas barrier layer may be laminated between the substrate layer and the sealant layer to secure mechanical strength of the pouch, block the inflow and outflow of gas or moisture from the outside of the secondary battery, and prevent leakage of an electrolyte from the inside of the pouch-type case. The gas barrier layer may include, for example, a metal, and in one embodiment, may be formed of an aluminum alloy thin film. When the gas barrier layer is formed using an aluminum alloy thin film, mechanical strength of a predetermined level or more may be secured, while being lightweight, and compensation for electrochemical properties caused by the electrode assembly and the electrolyte as well as heat dissipation may also be secured. The aluminum alloy thin film may include one or more metallic elements other than aluminum, for example, iron, copper, chromium, manganese, nickel, magnesium, silicon, and zinc. The thickness of the gas barrier layer may be about 40 μm to 100 μm, but is not limited thereto.

The sealant layer may be provided to completely seal an inside of the pouch-type case 505 when the pouch-type case accommodating the electrode assembly is sealed by thermally bonding at a sealing portion. For this purpose, the sealant layer may be formed of a material having excellent thermal bonding strength. The sealant layer may be formed of a material having insulation, corrosion resistance, and sealing properties. For example, since the sealant layer may directly contact the electrode assembly and/or the electrolyte inside the pouch-type case, the sealant layer may be formed of a material having insulation and corrosion resistance. In addition, since the sealant layer must completely seal the inside of the pouch-type case to block material movement between inside and outside, the sealant layer may be formed of a material having high sealing property (e.g., excellent thermal bonding strength). In order to secure such insulation, corrosion resistance, and sealing properties, the sealant layer may be formed of a polymer material. For example, the sealant layer may be made of one or more materials selected from polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber, and in one embodiment, the sealant layer may be made of a polyolefin resin such as polypropylene (PP) and/or polyethylene (PE). In this case, polypropylene may be composed of cast polypropylene (CPP), acid modified polypropylene (PPa), a polypropylene-ethylene copolymer, and/or a polypropylene-butylene-ethylene terpolymer. The thickness of the sealant layer may be, for example, about 30 μm to 130 μm, but is not limited thereto.

The pouch-type secondary battery 50 of the present disclosure may further include, without limitation, configurations included in a known pouch-type secondary battery, as long as the purpose of the present disclosure is not impaired.

Any known electrode assembly may be applied as the electrode assembly. The electrode assembly may include, for example, at least one unit cell, or may be a multi-stack cell. The multi-stack cell may refer, for example, to a stacked structure in which a separator is interposed between a positive electrode and a negative electrode three times or more. The unit cell may be, for example, a mono-cell or a bi-cell. The mono-cell may refer to a unit cell in which one or more positive electrodes and one or more negative electrodes are stacked with a separator interposed therebetween such that types of electrodes positioned on both surfaces are different, and the bi-cell may refer to a unit cell in which one or more positive electrodes and one or more negative electrodes are stacked with a separator interposed therebetween such that types of electrodes positioned on both surfaces are the same. The unit cell or the multi-stack cell may include, for example, a positive electrode, a negative electrode, and/or a separator. The electrode assembly may further include, for example, an electrode tab (e.g., a positive electrode tab and/or a negative electrode tab) for drawing current to the outside, and each of the electrode tabs may be electrically connected to the positive electrode or the negative electrode and may protrude in one direction from the electrode assembly. Each of the protruded electrode tabs may be connected to a positive electrode lead and/or a negative electrode lead, thereby enabling electrical connection with an external circuit. The electrode lead may penetrate or extend through a sealing portion and/or a terrace portion of the pouch-type case and may protrude to an outside of the pouch-type case. Accordingly, the electrode lead may form an electrical path between the electrode assembly and the external circuit. Further, the electrode assembly may have, for example, a wound type, a stacked type, a stack-and-folding type, or a lamination/stack type structure, but is not limited thereto.

The positive electrode may include, for example, a positive electrode current collector and a positive electrode active material layer formed on at least one surface of the positive electrode current collector. Examples of the positive electrode current collector include a thin plate made of aluminum, stainless steel, or nickel. In addition, the positive electrode current collector may be, for example, a porous body such as a reticulated or mesh shape may, or a current collector coated with an oxidation-resistant metal or alloy film to prevent oxidation. In some cases, the positive electrode current collector may be omitted. The positive electrode active material layer may include a known positive electrode active material, a binder, and/or a conductive material. The positive electrode active material may be, for example, a compound capable of reversible intercalation and deintercalation of lithium, and may be a lithium transition metal composite oxide including lithium and at least one transition metal selected from nickel, cobalt, manganese, and aluminum, but is not limited thereto. The binder may be, for example, at least one selected from polyvinylidene fluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene terpolymer, styrene-butadiene rubber, and fluorine rubber, but is not limited thereto. The conductive material may be, for example, at least one selected from graphite, carbon black, carbon nanotubes, metal powder, and conductive oxide, but is not limited thereto. The positive electrode active material layer may further include other known additives as long as the purpose of the present disclosure is not impaired.

The negative electrode may include, for example, a negative electrode current collector and a negative electrode active material layer. Examples of the negative electrode current collector include copper, stainless steel, aluminum, nickel, titanium, fired carbon, copper or stainless steel surface-treated with carbon, nickel, titanium, or silver, or an aluminum-cadmium alloy. In addition, like the anode collector, the cathode collector may have fine irregularities formed on the surface to strengthen the bonding power of the cathode active material, and may be used in various forms such as films, sheets, foils, nets, porous materials, foams, and non-woven materials. In some cases, the negative electrode current collector may be omitted. The negative electrode active material layer may include a known negative electrode active material, a binder, and/or a conductive material. The negative electrode active material may be, for example, a silicon-based negative electrode active material or a carbon-based negative electrode active material. The silicon-based negative electrode active material may be, for example, at least one selected from SiOₓ (0≤x<2) particles, Si—C composites, and Si—Y alloys (where Y is an element selected from alkali metals, alkaline earth metals, transition metals, Group 13 elements, Group 14 elements, rare earth elements, and combinations thereof). The carbon-based negative electrode active material may be, for example, at least one selected from artificial graphite, natural graphite, amorphous carbon, and graphitized mesocarbon microbeads, but is not limited thereto. The binder included in the negative electrode active material layer may be, for example, an aqueous binder or a rubber-based binder. The aqueous binder may be soluble in an aqueous solvent such as water and may be at least one selected from polyvinyl alcohol, polyacrylic acid, polyethylene glycol, polyacrylonitrile, polyacrylamide, carboxymethyl cellulose, and combinations thereof, but is not limited thereto. The rubber-based binder may not be easily soluble in an aqueous solvent such as water but may be well dispersible in an aqueous solvent, and may be, for example, at least one selected from styrene-butadiene rubber, hydrogenated nitrile-butadiene rubber, acrylonitrile-butadiene rubber, acrylic rubber, butyl rubber, fluorine rubber, and combinations thereof, but is not limited thereto. The conductive material included in the negative electrode active material layer may be, for example, at least one selected from graphite, carbon black, carbon nanotubes, metal powder, conductive oxide, and combinations thereof, but is not limited thereto.

The separator may have a function of physically separating electrodes, and any separator conventionally used may be used without particular limitation. For example, a material having low resistance to ion migration of the electrolyte and excellent electrolyte wettability may be used. The separator may be porous and may be made of a non-conductive or insulating material, and may be an independent member or a coating layer added to the positive electrode and/or the negative electrode. The separator may be a film formed of a polyolefin-based polymer, for example, polyethylene such as high-density polyethylene, linear low-density polyethylene, low-density polyethylene, or ultrahigh molecular weight polyethylene, polypropylene, polybutylene, or polypentene, which may be used either alone or a mixture thereof.

The secondary battery may further include, for example, known components such as an electrolyte.

The electrolyte may include an organic solvent and a lithium salt. The organic solvent may be any solvent capable of serving as a medium through which ions involved in electrochemical reactions of the battery are able to migrate, without particular limitation. The organic solvent may be, for example, an ester-based solvent such as methyl acetate, ethyl acetate, γ-butyrolactone, or ε-caprolactone; an ether-based solvent such as dibutyl ether or tetrahydrofuran; a ketone-based solvent such as cyclohexanone; an aromatic hydrocarbon-based solvent such as benzene or fluorobenzene; a carbonate-based solvent such as dimethyl carbonate (DMC), diethyl carbonate (DEC), methylethyl carbonate (MEC), ethylmethyl carbonate (EMC), ethylene carbonate (EC), or propylene carbonate (PC); an alcohol-based solvent such as ethanol or isopropyl alcohol; a nitrile-based solvent such as R—CN (where R is a C2-C20 linear, branched, or cyclic hydrocarbon group and may include a double bond, an aromatic ring, or an ether bond); an amide-based solvent such as dimethylformamide; a dioxolane-based solvent such as 1,3-dioxolane; or a sulfolane-based solvent. The lithium salt may be any compound capable of providing lithium ions used in the battery, without particular limitation. The lithium salt may be, for example, LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂. The concentration of the lithium salt may be in a range of about 0.1 M to 2.0 M. When the concentration of the lithium salt is within the above range in one embodiment, the electrolyte may exhibit excellent electrolyte performance with appropriate conductivity and viscosity, and lithium ions may effectively migrate.

A third aspect of the present disclosure may relate to a method of manufacturing the gas venting film 100 having different gas permeability between both surfaces, configured to discharge gas generated from an inside of a secondary battery to an outside while preventing air and water vapor from the outside from permeating into the secondary battery, in which the film has a ratio of forward permeability of gas generated from the inside of the secondary battery to reverse permeability of air of about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

Matters relating to the first aspect and/or the second aspect of the present disclosure may also be equally applied to the third aspect unless otherwise specifically described.

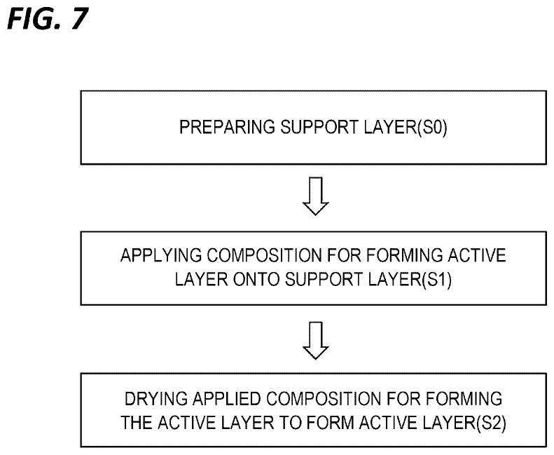

Referring to FIG. 7, a method of manufacturing the gas venting film 100 of the present disclosure may include, for example, a step (step S0) of preparing the support layer 10 and a step (step S1) of applying a composition for forming the active layer onto the support layer 10.

The S1 step may be performed by a method such as, for example, spin coating, slot-die coating, gravure coating, microgravure coating, dip coating, blade coating, bar coating, slit coating, or inkjet coating.

Step S1 may be performed by spin coating in one example, but may be performed without limitation by any coating method capable of precisely controlling coating thickness. Step S1 may be performed, for example, at a speed of about 100 rpm to 900 rpm. The speed may refer to a spin rate of a spin coater. In another example, Step S1 may be performed at a speed of about 150 rpm or more, 200 rpm or more, 250 rpm or more, 300 rpm or more, 350 rpm or more, 400 rpm or more, or 450 rpm or more, or at a speed of about 850 rpm or less, 800 rpm or less, 750 rpm or less, 700 rpm or less, 650 rpm or less, 600 rpm or less, or 550 rpm or less.

Step S1 may be performed, for example, for about 1 second to 100 seconds. In another example, Step S1 may be performed for about 5 seconds or more, 10 seconds or more, 15 seconds or more, 20 seconds or more, 25 seconds or more, or 30 seconds or more, or for about 90 seconds or less, 80 seconds or less, 70 seconds or less, 60 seconds or less, 50 seconds or less, 40 seconds or less, 30 seconds or less, 20 seconds or less, or 10 seconds or less.

By performing Step S1 at the above speed and/or for the above time, the present disclosure may form the active layer 20 with a thickness within the above range, thereby providing the gas venting film 100 having excellent resistance to an electrolyte and asymmetric gas permeability characteristics.

The composition for forming the active layer may include, for example, a polydimethylsiloxane precursor and a curing agent. A weight ratio of the polydimethylsiloxane precursor to the curing agent may be, for example, about 1 to 10.

The method of manufacturing the film of the present disclosure may further include, for example, a step (step S2) of drying the applied composition for forming the active layer to form the active layer 20.

Step S2 may be performed, for example, at a temperature of about 70° C. to 110° C. Step S2 may be performed, for example, using an oven.

Step S2 may be performed, for example, for about 12 hours or more. In another example, step S2 may be performed for about 30 hours or less or 24 hours or less.

By performing Step S2 at the above temperature and/or for the above time, the present disclosure may form the active layer 20 with a thickness within the above range, thereby providing the gas venting film 100 having excellent resistance to an electrolyte and asymmetric gas permeability characteristics.

Step S0 may include, for example, preparing the porous support 101 and/or forming the polymer coating layer 102 on at least one surface of the porous support 101. The step of forming the polymer coating layer 102 on at least one surface of the porous support 101 may include, for example, applying the polymer coating layer 102 on at least one surface of the porous support 101 and/or drying. The applying may be performed, for example, using a spin coater.

Hereinafter, embodiments are provided to describe the present disclosure in detail in order to explain the disclosed contents of the present disclosure as described above and functions and effects intended in the present disclosure. However, the embodiments may be modified into various other forms, and the scope of the present specification should not be construed as being limited to only the embodiments. It is emphasized that the embodiments are provided to describe the present disclosure to those skilled in the art on behalf of the present disclosure. In the following embodiments, films having different properties were prepared by changing a rotation speed and a time of a spin coater for applying a composition for forming an active layer on the polymer coating layer 101 of the support layer 10.

### Example 1

A film having the structure illustrated in FIG. 1, in which a support layer 10 and an active layer 20 were sequentially formed, was prepared.

The support layer 10 was prepared by casting a polymer coating layer solution onto a polyester nonwoven fabric (porous support 101) to form a polymer coating layer 102, followed by immersing the cast nonwoven fabric in water. The coating layer 102 had a thickness of 100 μm. The polymer coating layer solution was obtained by dissolving polysulfone solids in DMF (N,N-dimethylformamide) at 80-85° C. for 12 hours or longer, and the content of the polysulfone solids in the solution was 18 wt %.

Subsequently, the active layer 20 was formed on one surface of the support layer 10. The active layer 20 was prepared by applying, onto the polymer coating layer 101 of the support layer 10, an active layer-forming composition in which a PDMS precursor (Sylgard 184, Dow Chemical) and a curing agent (Sylgard 184, Dow Chemical) were mixed at a weight ratio of 5:1, followed by drying in an oven at 90° C. for 12 hours or longer. The application was performed at 500 rpm for 10 seconds, thereby forming the active layer 20 having a thickness of about 214.7 μm.

The resulting film 100 had a total thickness of about 314.7 μm.

### Example 2

The film 100 was prepared in the same manner as in Example 1 except that the active layer-forming composition was applied at 500 rpm for 20 seconds to form the active layer 20 having a thickness of about 150.3 μm. The resulting film 100 had a total thickness of about 250.3 μm.

### Example 3

The film 100 was prepared in the same manner as in Example 1 except that the active layer-forming composition was applied at 500 rpm for 30 seconds to form the active layer 20 having a thickness of about 127.5 μm. The resulting film 100 had a total thickness of about 227.5 μm.

### Example 4

The film 100 was prepared in the same manner as in Example 1 except that the active layer-forming composition was applied at 1,000 rpm for 10 seconds to form the active layer 20 having a thickness of about 116.6 μm. The resulting film 100 had a total thickness of about 226.6 μm.

### Example 5

The film 100 was prepared in the same manner as in Example 1 except that the active layer-forming composition was applied at 1,000 rpm for 20 seconds to form the active layer 20 having a thickness of about 94.2 μm. The resulting film 100 had a total thickness of about 194.2 μm.

### Example 6

The film 100 was prepared in the same manner as in Example 1 except that the active layer-forming composition was applied at 1,000 rpm for 30 seconds to form the active layer 20 having a thickness of about 88.0 μm. The resulting film 100 had a total thickness of about 188.0 μm.

### Example 7

The film 100 was prepared in the same manner as in Example 1 except that the active layer-forming composition was applied at 1,500 rpm for 10 seconds to form the active layer 20 having a thickness of about 76.4 μm. The resulting film 100 had a total thickness of about 176.4 μm.

### Example 8

The film 100 was prepared in the same manner as in Example 1 except that the active layer-forming composition was applied at 2,000 rpm for 10 seconds to form the active layer 20 having a thickness of about 63.7 μm. The resulting film 100 had a total thickness of about 163.7 μm.

### Evaluation Example 1. Gas Permeability

The gas permeability of the films was measured using a constant-pressure, variable-volume method. After the permeability stabilized (after more than 2 hours), the gas permeability was quantified using a gas flowmeter. For example, the film was mounted on a pressure cell (filter holder type), and a gas was applied at a constant pressure to measure the flow rate of the gas permeating through the film. The measurements were conducted at room temperature, and the forward CO₂ permeability and the reverse air permeability were measured under pressures of 50 psi or 15 psi.

The results measured under 50 psi are shown in Table 1 below, and the results measured under 15 psi are shown in Table 2 below.

TABLE 1

| | Forward CO₂ | Reverse Air | |
|---|---|---|---|
| | Permeability | Permeability | |
| Example | (GPU) | (GPU) | Selectivity |
| Example 1 | 10.6 | 1.1 | 9.6 |
| Example 2 | 14.2 | 1.4 | 10.1 |
| Example 3 | 18.3 | 1.5 | 12.2 |
| Example 4 | 19.1 | 1.6 | 11.9 |
| Example 5 | 25.6 | 2.2 | 11.6 |
| Example 6 | 29.7 | 2.4 | 12.4 |
| Example 7 | 28.9 | 2.6 | 11.1 |
| Example 8 | 38.2 | 3.5 | 10.9 |

TABLE 2

| | Forward CO₂ | Reverse Air | |
|---|---|---|---|
| | Permeability | Permeability | |
| Example | (GPU) | (GPU) | Selectivity |
| Example 1 | 3 | 0.3 | 10 |
| Example 2 | 4.1 | 0.4 | 10.25 |
| Example 3 | 5.3 | 0.5 | 10.6 |
| Example 4 | 5.5 | 0.5 | 11 |
| Example 5 | 7.5 | 0.6 | 12.5 |
| Example 6 | 8.4 | 0.7 | 12 |
| Example 7 | 8.3 | 0.8 | 10.375 |
| Example 8 | 10.1 | 1 | 10.1 |

(“Selectivity” in Tables 1 and 2 refers to the ratio of the forward CO₂ permeability to the reverse air permeability.)

As shown in Tables 1 and 2, the films 100 manufactured according to the embodiments of the present disclosure exhibited selectivity of 8 or higher in all of Examples 1 to 8.

### Evaluation Example 2. Electrolyte Resistance

Electrolyte resistance was evaluated by visually observing or microscopically (DM) observing whether the films swelled upon contact with an electrolyte.

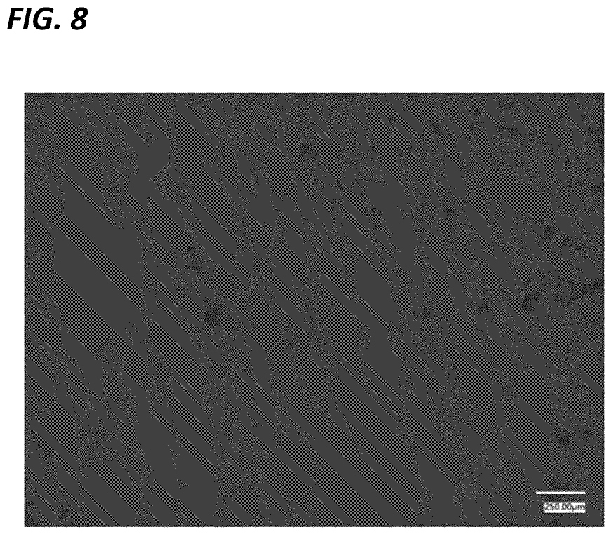

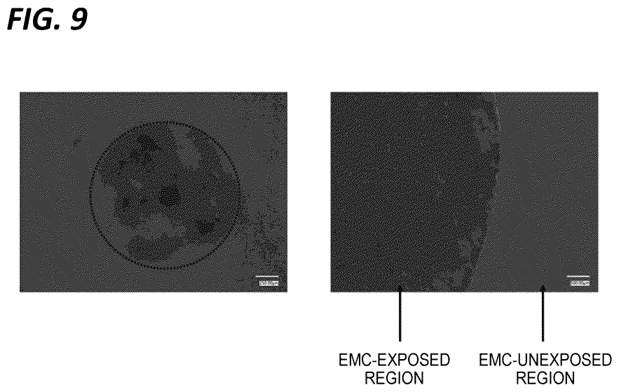

For example, when an electrolyte (EMC) was dropped onto the active layer of the film, the films of Examples 1 to 3 did not absorb the electrolyte and it remained on the surface until it evaporated, as illustrated in FIG. 8. In contrast, in the films of Examples 4 to 8, which were relatively thinner than the films of Examples 1 to 3, the electrolyte penetrated into the films and even broke through them, as illustrated in FIG. 9. In addition, among the films of Examples 4 to 8, the thinner the film, the faster the penetration rate of the electrolyte.

### Evaluation Example 3. Tensile Strength of the Support Layer

The tensile strength of the support layer was measured by testing five specimens (100 mm×10 mm) at a speed of 100 mm/min using a UTM, and taking the average value as the tensile strength of the support layer. As a result, the support layers of the films of Examples 1 to 8 exhibited a tensile strength of 2 kgf/mm².

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A gas venting film having different gas permeability characteristics between both surfaces, configured to discharge gas generated from an inside of a secondary battery to an outside while preventing air and water vapor from the outside from permeating into the secondary battery, the gas venting film comprising an active layer and a support layer from a side facing the inside of the secondary battery,
wherein the active layer includes polydimethylsiloxane, and
a ratio of forward permeability of gas generated from the inside of the secondary battery to reverse permeability of air is about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

2. The gas venting film according to claim 1, wherein the active layer is derived from a polydimethylsiloxane precursor and a curing agent.

3. The gas venting film according to claim 2, wherein a weight ratio of the polydimethylsiloxane precursor to the curing agent is about 1 to 10.

4. The gas venting film according to claim 1, wherein the active layer includes at least one of polyimide, polytetrafluoroethylene, polypropylene, fluorine-based polymers, or combinations thereof.

5. The gas venting film according to claim 1, wherein a thickness ratio of the support layer to the active layer is about 0.85 or less.

6. The gas venting film according to claim 1, wherein the active layer has a thickness of about 120 μm to 1,000 μm.

7. The gas venting film according to claim 1, wherein the support layer includes a porous support and a polymer coating layer on at least one surface of the porous support.

8. The gas venting film according to claim 7, wherein the porous support is in a nonwoven form, a woven form, or a mesh form in which polymer fibers are irregularly entangled.

9. The gas venting film according to claim 7, wherein the polymer coating layer includes at least one of polysulfone, polyethersulfone, polycarbonate, polyethylene oxide, polyimide, polyetherimide, polyether ether ketone, polypropylene, polymethylpentene, polymethyl chloride, polyvinylidene fluoride, or combinations thereof.

10. The gas venting film according to claim 1, wherein the support layer has a tensile strength of from about 0.1 kgf/mm² to 10 kgf/mm².

11. The gas venting film according to claim 1, wherein the support layer has a thickness of less than about 140 μm.

12. The gas venting film according to claim 1, wherein the gas venting film has a thickness of from about 200 μm to 1,000 μm.

13. The gas venting film according to claim 1, wherein the active layer and the support layer are adjacent to each other.

14. A secondary battery comprising, at least in part, the gas venting film of claim 1, wherein a gas generated from the inside of the secondary battery is non-destructively discharged to the outside through the gas venting film.

15. A method for manufacturing a gas venting film having different gas permeability characteristics between both surfaces, configured to discharge gas generated from an inside of a secondary battery to an outside while preventing air and water vapor from the outside from permeating into the secondary battery, the method comprising:
applying a composition for forming an active layer on a support layer,
wherein the gas venting film has a ratio of forward permeability of gas generated from the inside of the secondary battery to reverse permeability of air of about 2 or more under a relative pressure of about 15 psi or about 50 psi, the forward direction being from the inside of the secondary battery toward the outside of the secondary battery, and the reverse direction being from the outside of the secondary battery toward the inside of the secondary battery.

16. The method according to claim 15, wherein the applying is performed at a speed of from about 100 rpm to 900 rpm.

17. The method according to claim 15, wherein the applying is performed for from about 1 second to 100 seconds.

18. The method according to claim 15, wherein the composition for forming the active layer includes a polydimethylsiloxane precursor and a curing agent.

19. The method according to claim 18, wherein a weight ratio of the polydimethylsiloxane precursor to the curing agent is about 1 to 10.

20. The method according to claim 15, wherein the composition for forming the active layer incudes at least one selected from polyimide, polytetrafluoroethylene, polypropylene, fluorine-based polymers, and combinations thereof.
